(19) United States
(12) Patent Application Publication
(10) Pub. No.: US 2025/0303374 A1
(43) Pub. Date: Oct. 2, 2025

(54) DRIVE SHAFT SYSTEM FOR USE WITH A CONTAINER FOR MIXING A FLUID AND A CONTAINER HOLDER

(71) Applicant: APPLIKON BIOTECHNOLOGY B.V., JG DELFT (NL)

(72) Inventors: Wilbert Timotheüs WALVOORT, JG DELFT (NL); Jeroen Johannes Theodorus KERKLAAN, JG DELFT (NL)

(21) Appl. No.: 18/863,024

(22) PCT Filed: May 10, 2023
(86) PCT No.: PCT/NL2023/050251

§ 371 Date: Nov. 5, 2024

(30) Foreign Application Priority Data
May 10, 2022 (NL) 2031815

(51) Int. Cl. B01F 27/88; B01F 27/213; B01F 35/41; B01F 35/513; B01F 101/44

(52) U.S. Cl. CPC B01F 27/88; B01F 27/213; B01F 35/4111; B01F 35/413; B01F 35/513; B01F 2101/44

(57) ABSTRACT

The disclosure relates to a drive shaft system (1) for use with a container for mixing a fluid, being a container for a bioreaction, and a container holder for holding the container, comprising: —a drive shaft coupling (4) having: a container connection (5) for connecting the drive shaft coupling to the container; a motor connection (6), for detachably connecting the drive shaft coupling to a stationary part of a motor of the container holder, provided with a first alignment element (25, 26) to be rotationally aligned with a second alignment element (27, 28) provided on the stationary part; —a drive shaft (9), rotatably arranged in the drive shaft coupling, having: a first drive shaft end (10) configured for detachable coupling to a rotatable output shaft end of the motor; a second drive shaft end (12); and an agitation device (13), connected to the drive shaft.

### FIELD

The present disclosure relates to a drive shaft system for use with a container for mixing a fluid and a container holder, a container assembly comprising such a drive shaft system and a container, a container holder for use with such a drive shaft system or such a container assembly, as well as a method for mounting such a container assembly in such a container holder.

### BACKGROUND

Installing a container, for instance a single-use production container, such as a bioreactor bag, into a, for instance multi-use, container holder is often a cumbersome and lengthy task that may require multiple operators. A drive shaft system of the container for instance has to be properly connected to a motor of the container holder, in order to drive an agitation device inside the container. Furthermore, the container must also be safely suspended in the bioreactor holder. The current process may lead to errors and improper installation. US 2005/239198 A1 discloses a stirred-tank reactor system preferably for use as a disposable bioreactor. The bioreactor system e.g. comprises a flexible bag with an opening and an agitation shaft with an impeller. The agitation shaft is connectable to a bearing, which can be sealed to the bag through seals or O-rings. An upper end of the agitation shaft may be releasably connected to a motor coupling. NL 2003460 C2 furthermore discloses a stirrer for stirring e.g. liquid foods, with an impeller and at least one coupling means, provided at one end of a shaft, for releasably coupling the stirrer to a “countercoupling” means of a drive motor. US 2011/188928 A1 moreover discloses a mixer coupled with a support housing. The mixer is connected to a container, e.g. comprising a flexible bag. The container as well as a drive shaft of the mixer can be releasably connected to a motor mount with a self-aligning coupling.

An object of the present disclosure is thus to facilitate installation of a container into a container holder.

### SUMMARY

According to the present disclosure, a drive shaft system for use with a container for mixing a fluid and a container holder is provided, wherein the container for mixing the fluid is a container for a bioreaction, comprising:
a drive shaft coupling having:
a container connection for connecting the drive shaft coupling to the container;
a motor connection for detachably connecting the drive shaft coupling to a stationary part of a motor of the container holder, wherein the motor connection is provided with a first alignment element, such as notch or a protrusion, to be rotationally aligned with a second alignment element, such as a protrusion or a notch, provided on the stationary part of the motor;
a drive shaft, rotatably arranged in the drive shaft coupling, having:
a first drive shaft end configured for detachable coupling to a rotatable output shaft end of the motor;
a second drive shaft end; and
an agitation device, connected to the drive shaft, preferably to the second drive shaft end,
wherein, in an operational state, the drive shaft is configured for being driven around a longitudinal axis of the drive shaft by the motor, in order to rotate the agitation device for mixing the fluid.

The above drive shaft system makes it easy to install the container, such as a bioreactor bag, in the holder. The drive shaft coupling in particular allows for connection of the drive shaft with the rotatable output shaft end of the motor for driving the agitation device in the container, whereas at the same time allowing for mounting the container in the holder. Thus, the container may be installed by a single operator. Furthermore, proper rotational alignment between the container on the one hand and the container holder is advantageously facilitated.

An embodiment relates to an aforementioned drive shaft system, wherein the motor connection is provided with multiple first alignment elements, such as two, three, four, or even more first alignment elements.

As mentioned in the foregoing, the (multiple) first alignment element(s) and/or (multiple) second alignment element(s) may comprise a notch, protrusion or any other visually discernible feature. It is furthermore conceivable that the (multiple) first alignment element(s) and/or (multiple) second alignment element(s) are configured to provide an audible sound upon proper alignment, such as a click. It is also conceivable that the (multiple) first alignment element(s) and/or (multiple) second alignment element(s) are configured to generate an electronic signal upon proper alignment, e.g. by using appropriate electronic sensors.

According to the invention, the container for mixing the fluid is a container for a bioreaction. The container may, however, also be comprised by a media and feed preparation system, a seed bioreactor, a hold vessel, a buffer preparation system, et cetera. The skilled person will also understand that the expression fluid may relate to a liquid as such, but also to a substance exhibiting fluid-like behavior, such as comprising (spherical) microcarriers, which may be liquid or solid.

An embodiment relates to an aforementioned drive shaft system, wherein the first alignment element and/or the multiple first alignment elements the second alignment element and/or the multiple second alignment elements are provided in such a way, that, in the operational state, inlet and/or outlet ports and/or sensor ports of the container are situated near a mounting opening of the container holder. Thus, proper rotational alignment between the container on the one hand and the container holder is advantageously facilitated. Thus, the inlet and/or outlet ports and/or sensor ports are easily accessible to the operator.

An embodiment relates to an aforementioned drive shaft system, wherein the container is configured for single use. Thus, the container does not have to be cleaned, sterilized, et cetera, but can be disposed of after use.

In the context of the present patent application, “single-use” container means a culture vessel that is clearly to be disposed of after (single) use. This reduces the risk of cross contamination, enhances biological and process safety, reduces cleaning and validation requirements and, ultimately, leads to lower costs. In contrast to traditional stainless steel “multi-use” systems, e.g. a plastic bag may be used as the culture vessel. Single-use containers are especially suitable for any kind of biopharmaceutical product. In the field, “multi-use”, by contrast, means a culture vessel that is clearly to be reused. Such a culture vessel needs to be cleaned, sterilized, et cetera, after each use.

However, in the context of the present patent application “multi-use” generally refers to the reusability of the container holder. A single-use container may advantageously be installed in such a multi-use container holder. Clearly, only the single-use container is then to be disposed of after a single use—not the multi-use container holder, which is obviously to be reused.

An embodiment relates to an aforementioned drive shaft system, wherein the container is a rigid container, such as a plastic container. Preferably, the rigid container is again configured for single use/disposability. The container may be at least partially rigid. The container may e.g. comprise a rigid bottom shell, with flexible container sides. The container may also be wholly rigid, such as in case of the aforementioned plastic container.

An embodiment relates to an aforementioned drive shaft system, wherein the container is a flexible container. Such a flexible container is e.g. easy to transport. The container is may be at least partially flexible. The container may e.g. again comprise a rigid bottom shell, with flexible container sides. The container may also be wholly flexible, such as in case of a bag.

An embodiment relates to an aforementioned drive shaft system, wherein the flexible container comprises a bag, wherein the container connection is a bag connection for connecting the drive shaft coupling to the bag.

An embodiment relates to an aforementioned drive shaft system, wherein the first drive shaft end is configured to be self-aligning with the motor output shaft end of the motor. Thus, establishing a proper connection between the motor output shaft and the drive shaft in order to efficiently transfer the motor's torque to the drive shaft is facilitated.

An embodiment relates to an aforementioned drive shaft system, wherein the first drive shaft end comprises one or more alignment teeth spaced-apart in a circumferential direction along the first drive shaft end. Such alignment teeth (or splines) facilitate proper connection between the teeth of the motor output shaft end and the (alignment) teeth of the drive shaft.

An embodiment relates to an aforementioned drive shaft system, wherein the one or more alignment teeth comprise two circumferentially opposing alignment surfaces converging towards each other in an insertion direction. Thus, when such “arrow-shaped” alignment teeth are inserted in the (longitudinal) insertion direction into or onto the motor output shaft end, the alignment teeth automatically rotate into their proper position with respect to (the teeth of) the motor output shaft end.

An embodiment relates to an aforementioned drive shaft system, wherein the two opposing alignment surfaces enclose an angle of 90 degrees or less, such as 30-60 degrees. Relatively sharp angles, i.e. less than 90 degrees, are preferred, to facilitate proper insertion into or onto the motor output shaft and rotation of the alignment teeth to their desired rotational position.

An embodiment relates to an aforementioned drive shaft system, wherein the two opposing alignment surfaces converge at an insertion edge, wherein the insertion edge is inclined backwards with respect to the insertion direction. Thus, insertion becomes even easier.

An embodiment relates to an aforementioned drive shaft system, wherein the container connection comprises a tri-clamp connection. Such a tri-clamp connection is relatively easy to produce and allows the weight of the container to be safely suspended from the drive shaft system.

Another aspect of the disclosure concerns a container assembly comprising an aforementioned drive shaft system and a container for mixing a fluid, wherein the container for mixing the fluid is a container for a bioreaction, wherein the drive shaft coupling is connected to the container with the container connection, wherein a drive shaft portion provided with the agitation device extending between the drive shaft coupling and the second drive shaft end is enclosed by the container. In line with the rationale behind the disclosure, such a container assembly can be conveniently installed in the bioreactor holder “in one go”, by a single operator.

An embodiment relates to an aforementioned container assembly, wherein the container is configured for single use.

An embodiment relates to an aforementioned container assembly, wherein the container is a rigid container.

An embodiment relates to an aforementioned container assembly, wherein the container is a flexible container.

An embodiment relates to an aforementioned container assembly, wherein the flexible container comprises a bag, wherein the container connection is a bag connection for connecting the drive shaft coupling to the bag.

An embodiment relates to an aforementioned container assembly, wherein, in an inoperational state, the flexible container is folded around the drive shaft portion extending between the drive shaft coupling and the second drive shaft end.

An embodiment relates to an aforementioned container assembly, wherein the flexible container is configured for expanding radially away from the drive shaft portion extending between the drive shaft coupling and the second drive shaft end to reach the operational state from the inoperational state. During transportation, the flexible container, such as a bioreactor bag, is ‘rolled-up’ around the drive shaft portion. During filling, the flexible container unfolds radially, which—distance-wise—leads to a much shorter unfolding than when the bag would unfold upward or downward, i.e. axially. Easier unfolding will result in a better and more reliable fit to the flexible container holder, with less folds. Folds are undesirable because cells may accumulate there during a bioreaction process and differentiate spontaneously during the bioprocess.

Another aspect of the disclosure concerns a container holder for holding a container for mixing a fluid, wherein the container for mixing the fluid is a container for a bioreaction, for use with an aforementioned drive shaft system or an aforementioned container assembly, comprising:
the motor with the stationary part for detachable connection to the motor connection of the drive shaft coupling, wherein the second alignment element is provided on the stationary part of the motor, for rotational alignment with the first alignment element provided on the motor connection of the drive shaft coupling;
wherein the motor comprises the rotatable output shaft end configured for detachable coupling to the first drive shaft end for driving the drive shaft around the longitudinal axis, in order to rotate the agitation device.

An embodiment relates to an aforementioned container holder, wherein multiple second alignment elements are provided on the stationary part of the motor, such as two, three, four or more.

An embodiment relates to an aforementioned container holder, wherein the first alignment element and/or the multiple first alignment elements the second alignment element and/or the multiple second alignment elements are provided in such a way, that, in the operational state, inlet and/or outlet ports and/or sensor ports of the container are situated near a mounting opening of the container holder.

An embodiment relates to an aforementioned container holder, wherein the stationary part is detachably connectable to the motor connection of the drive shaft coupling and wherein the rotatable output shaft end is detachably couplable to the first drive shaft end for driving the drive shaft around the longitudinal axis, in order to rotate the agitation device.

An embodiment relates to an aforementioned container holder, wherein the stationary part of the motor comprises one or more gripping elements configured for radially engaging the motor connection for detachably connecting the drive shaft coupling to the stationary part of the motor. Thus, the drive shaft coupling can be easily connected to, and disconnected from, the stationary part of the motor—without additional mounting tools being required.

An embodiment relates to an aforementioned container holder, wherein the one or more gripping elements are configured for radially engaging an outer circumference of the motor connection, wherein the one or more gripping elements are configured to engage the outer circumference in a radially inward position and to disengage the outer circumference in a radially outward position.

An embodiment relates to an aforementioned container holder, wherein the one or more gripping elements are spring-biased towards the radially inward position. Thus, less force is required by the operator to connect the drive shaft coupling to the stationary part of the motor. Furthermore, accidental disengagement of the gripping elements is prevented.

An embodiment relates to an aforementioned container holder, wherein the one or more gripping elements comprise a pair of radially opposing gripping elements. Such radially opposing gripping elements can be easily pressed towards each other by the operator, using a single hand.

An embodiment relates to an aforementioned container holder, wherein the pair of gripping elements are moved towards each other in the radially inward position and away from each other in the radially outward position.

An embodiment relates to an aforementioned container holder, wherein the stationary part of the motor comprises a release mechanism, such as a release button, that, when activated, such as when pressed, causes the one or more gripping elements to radially disengage the motor connection. Thus, removal of the drive shaft coupling from the stationary part of the motor is facilitated.

An embodiment relates to an aforementioned container holder, wherein the stationary part of the motor comprises a safety mechanism, such as a safety latch, that, when activated, such as when pressed, prevents the one or more gripping elements from accidentally disengaging the motor connection, thereby increasing safety and preventing accidents.

An embodiment relates to an aforementioned container holder, wherein the safety mechanism prevents the release mechanism from being accidentally activated. Thus, an additional safety measure is present to prevent the drive shaft coupling (and the container) from accidentally disengaging from the stationary part of the motor.

Another aspect of the disclosure concerns a method for mounting an aforementioned container assembly in an aforementioned container holder for holding the container, comprising the step of:
detachably connecting the motor with the stationary part to the motor connection of the drive shaft coupling, in such a way, that the first drive shaft end is able to drive the drive shaft around the longitudinal axis, in order to rotate the agitation device, and in such a way, that the first alignment element is rotationally aligned with the second alignment element provided on the stationary part of the motor.

An embodiment relates to an aforementioned method, comprising the further step of:
rotationally aligning the first alignment element and second alignment element in such a way, that, in the operational state, the inlet and/or outlet ports and/or sensor ports of the container are situated near the mounting opening of the container holder.

An embodiment relates to an aforementioned method, comprising the further step of:
detachably connecting the drive shaft coupling to the stationary part of the motor, in such a way, that the one or more gripping elements of the stationary part of the motor radially engage the motor connection.

### BRIEF DESCRIPTION OF THE DRAWINGS

The disclosure will be explained in more detail below, with reference to illustrative embodiments shown in the drawings. Therein:

FIG. 1 shows an example embodiment of a container holder with an example embodiment of a container assembly arranged therein;

FIG. 2 shows a cross-section of an example embodiment of a container holder with an example embodiment of a container assembly arranged therein, such as the example embodiment of the container holder of FIG. 1;

FIG. 3 shows a perspective view of an example embodiment of a container holder with an example embodiment of a container assembly arranged therein, such as the example embodiments of FIGS. 1 and 2;

FIG. 4 shows a perspective view of an example embodiment of a drive shaft system, such as for use with the example embodiments of FIGS. 1-3;

FIG. 5 shows a cutaway view of an upper region of an example embodiment of a container holder with an example embodiment of a container assembly arranged therein, such as the example embodiments of FIGS. 1-3;

FIG. 6 shows a perspective view of an example embodiment of a first drive shaft end of the drive shaft configured for detachable coupling to an example embodiment of a rotatable output shaft end of the motor, such as for use with the example embodiments of FIGS. 1-5; and

FIG. 7 shows a plan view of an example embodiment of a stationary part of the motor comprising one or more gripping elements configured for radially engaging the motor connection for detachably connecting the drive shaft coupling to the stationary part of the motor, such as for use with the example embodiments of FIGS. 1-5.

### DETAILED DESCRIPTION

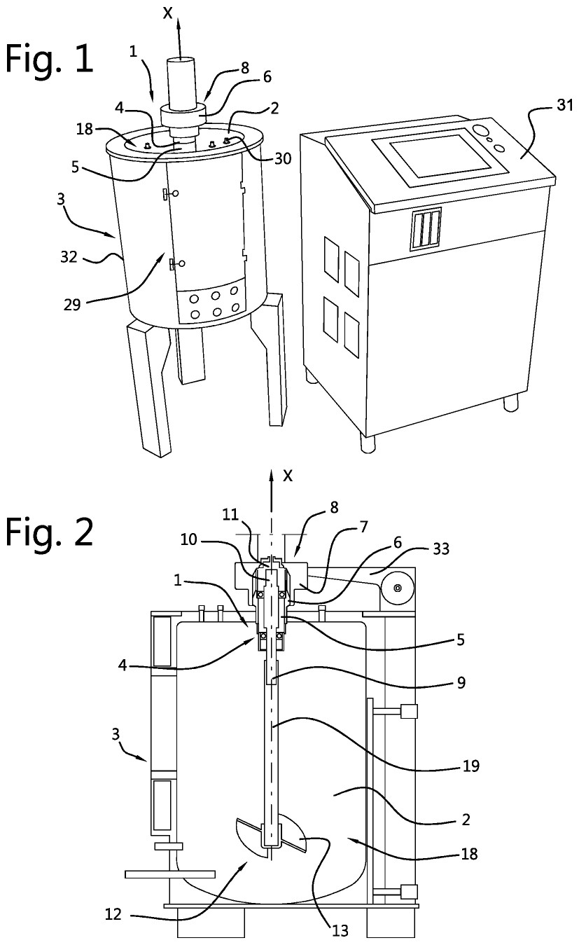

FIG. 1 shows an example embodiment of a container holder 3, for instance a flexible container holder 3 as shown in FIG. 1, such as a bioreactor bag holder 3, with an example embodiment of a container assembly 18 arranged therein, comprising a drive shaft system 1 and a container 2, for instance a flexible container 2, preferably for single-use, such as a bioreactor bag 2 as shown in FIG. 1. The container 2 may, however, also be comprised by (not shown) a media and feed preparation system, a seed bioreactor, a hold vessel, a buffer preparation system, et cetera—basically any mixing system wherein the drive shaft system according to the present disclosure can be used. Please note that the expression “flexible” in “flexible container holder 3” relates to the flexibility (such as foldability) of the flexible container 2, not of the holder 3, which is usually rigid. The flexible container holder 3 and/or the flexible container 2 as shown in FIG. 1 may be configured for an operational/work volume of 1-10.000 l, preferably 10-5.000 l, more preferably 50-3.000 l, such as 40-60 l. The flexible container holder 3 is configured for holding the flexible container 2 inside an enclosure 32, such as a cylindrical enclosure 32, having a substantially open top side and a substantially closed bottom side. The drive shaft coupling 4 is connected to the flexible container 2 with a container connection 5 in the form of a bag connection 5. The flexible container holder 3 comprises a motor 8 with a stationary part 7 (as more clearly shown in FIG. 2) for detachable connection to a motor connection 6 of the drive shaft coupling 4. For the example embodiment shown, the bioreaction process taking place in the flexible container 2, in the operational state, may be controlled by means of a control panel 31 and various controllers. The flexible container 2 may be mounted or arranged in the enclosure 32 of the flexible container holder 3 via a mounting opening 29, such as a door 29, e.g. a door 29 that opens sideways. The container 2, in some embodiments, may also be rigid, such as made of plastic. Preferably, the container 2 then is also configured for single use, i.e. to be disposed of after use. The container 2 may also be partially rigid or partially flexible, e.g. comprising a rigid bottom shell with flexible container sides.

As shown in FIG. 2, the motor 8 may comprise a rotatable output shaft end 11 configured for detachable coupling to a first drive shaft end 10 of a drive shaft 9 for driving (e.g., imparting torque and rotation to) the drive shaft 9 around a longitudinal axis X, in order to rotate an agitation device 13, such as an impeller 13, for mixing the fluid. The container holder 3, such as the flexible container holder 3 as shown, may furthermore comprise a holder arm 33. The motor 8 may be attached to the holder arm 33, such as an end thereof, situated on the longitudinal axis X, above the flexible container 2. The flexible container 2 may be suspended from the holder arm 33 via the motor connection 6 of the drive shaft coupling 4. The agitation device 13 may comprise a three-bladed screw or the like.

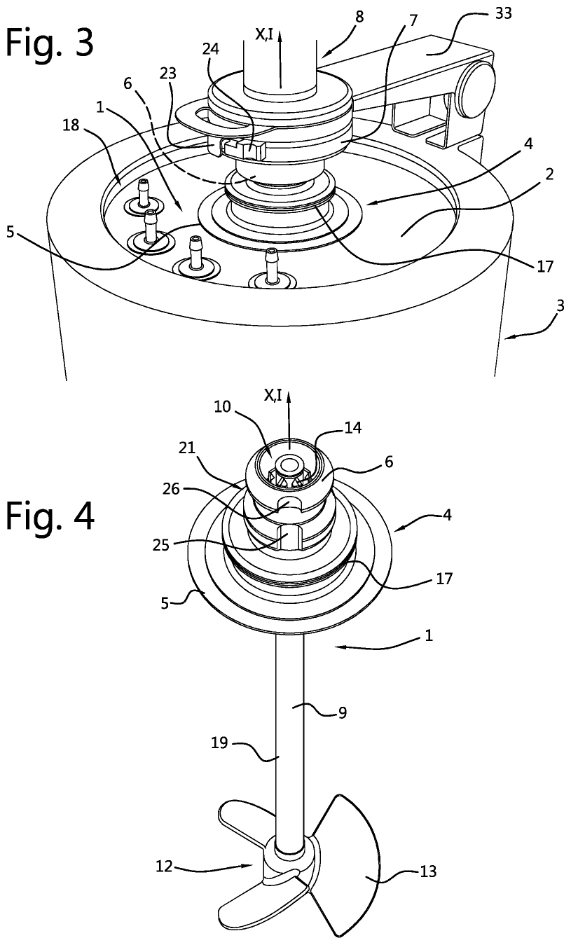

As can be seen from FIGS. 3, 4 and 5, the container connection 5 in the form of the bag connection 5 may comprise a tri-clamp connection 17, although other connection means are also conceivable.

As shown in FIGS. 4 and 7, the motor connection 6 for detachably connecting the drive shaft coupling 4 to the stationary part 7 of the motor 8 of the container holder 3, such as the flexible container holder 3 as shown, may be provided with a splined connection and comprises a first alignment element 25, 26, such as a notch 25, 26 or a protrusion (FIG. 4), to be rotationally aligned with a second alignment element 27, 28, such as a protrusion 27, 28 or a notch (FIG. 7), provided on the stationary part 7 of the motor 8. The first alignment element 25, 26 and second alignment element 27, 28 are provided in such a way, that, in the operational state, inlet and/or outlet ports 30 and/or sensor ports 30 of the container 2, in case the flexible container 2, are (rotationally) situated near a mounting opening 29 of the flexible container holder 3 (as shown in FIG. 1). As mentioned in the foregoing, the (multiple) first alignment element(s) 25, 26 and/or (multiple) second alignment element(s) 27, 28 may comprise a notch 25, 26, protrusion 27, 28 or any other visually discernible feature. It is furthermore conceivable that the (multiple) first alignment element(s) 25, 26 and/or (multiple) second alignment element(s) 27, 28 are configured to provide an audible sound upon proper alignment, such as a click. It is also conceivable that the (multiple) first alignment element(s) 25, 26 and/or (multiple) second alignment element(s) 27, 28 are configured to generate an electronic signal upon proper alignment, e.g. by using appropriate electronic sensors. The electronic signal may subsequently be processed for rotational alignment purposes.

Generally, speaking, apart from providing the first alignment element 25, 26 and second alignment element 27, 28 in such a way, that, in the operational state, inlet and/or outlet ports 30 and/or sensor ports 30 of the container 2 are (rotationally) situated near a mounting opening 29 of the flexible container holder 3 (as shown in FIG. 1), the first alignment element 25, 26 and second alignment element 27, 28 may also be configured for ensuring other predetermined rotational orientations (around the longitudinal axis X) between the stationary part 7 of the drive motor 8 and/or the container holder 3 on the one hand and the flexible container 2 on the other hand.

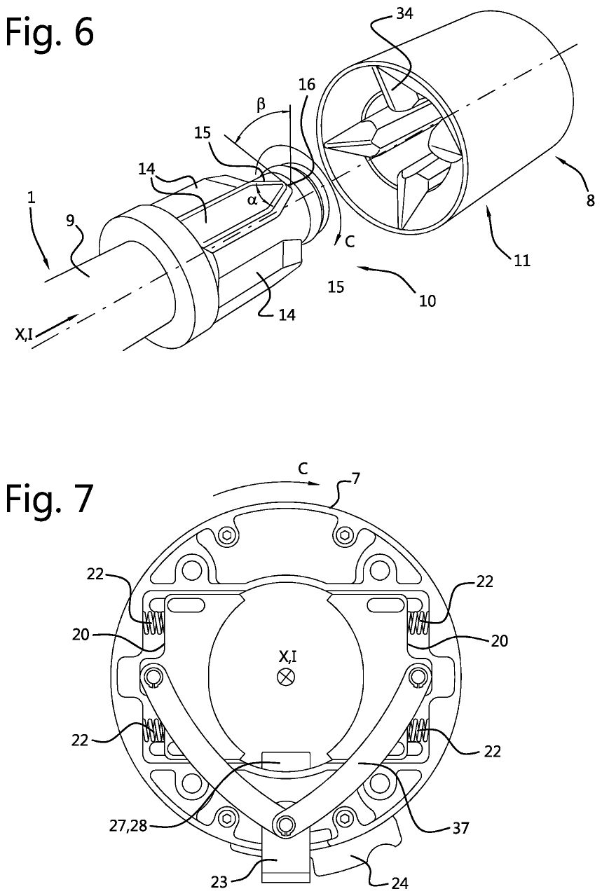

As can be seen from FIG. 6, the first drive shaft end 10 is preferably configured to be self-aligning with the motor output shaft end 11 of the motor 8. Thereto, the first drive shaft end 10 may comprise one or more splines or alignment teeth 14 spaced-apart in a circumferential direction C along the first drive shaft end 10. The one or more alignment teeth 14 may also comprise two circumferentially opposing alignment surfaces 15 converging towards each other in an insertion direction I. The two opposing alignment surfaces 15 may enclose an angle (a) of 90 degrees or less, such as 30-60 degrees. Moreover, the two opposing alignment surfaces 15 may converge at an insertion edge 16, wherein the insertion edge 16 is inclined backwards (p) with respect to the insertion direction I. The rotatable output shaft end 11 may comprises similar alignment teeth 34 having a shape complementary to the shape of the alignment teeth 14. Three, four or more alignment teeth 14, 34 may be provided, depending e.g. on the torque to be transferred.

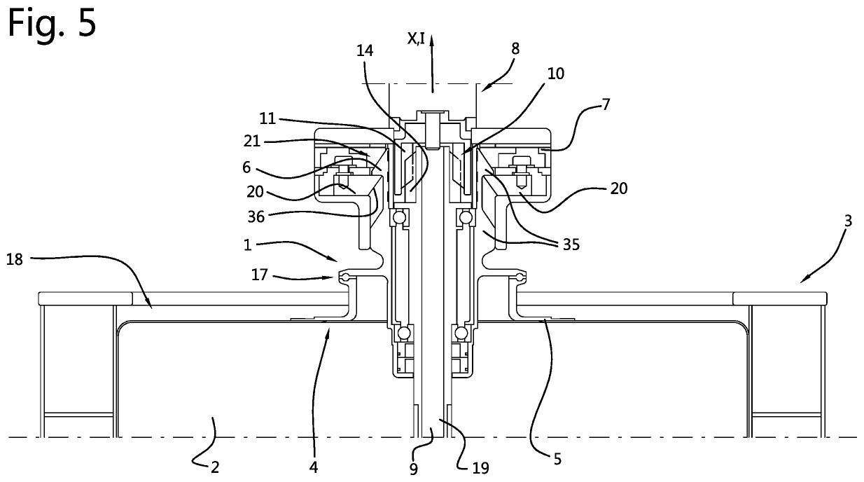

As shown in FIGS. 5 and 7, the stationary part 7 of the motor 8 may comprise one or more gripping elements 20 configured for radially engaging the motor connection 6 for detachably connecting the drive shaft coupling 4 to the stationary part 7 of the motor 8. The one or more gripping elements 20 are preferably configured for radially engaging an outer circumference 21 of the motor connection 6, wherein the one or more gripping elements 20 are configured to engage the outer circumference 21 (as e.g. depicted in FIG. 4) in a radially inward position and to disengage the outer circumference 21 in a radially outward position. The one or more gripping elements 20 are preferably spring-biased 22 towards the radially inward position. The one or more gripping elements 20 may furthermore comprise a pair of radially opposing gripping elements 20. The pair of gripping elements 20 may be moved towards each other in the radially inward position and away from each other in the radially outward position. The stationary part 7 of the motor 8 may furthermore comprise a release mechanism 23, such as a release button 23, that, when activated, such as when pressed, causes the one or more gripping elements 20 to radially disengage the motor connection 6. The force exerted on the release button 23 may be transferred to the gripping elements 20 by means of a mechanical linkage 37. As shown in FIG. 7, the stationary part 7 of the motor 8 may also comprise a safety mechanism 24, such as a safety latch 24, that, when activated, such as when pressed, prevents the one or more gripping elements 20 from accidentally disengaging the motor connection 6. Therein, the safety mechanism 24 may prevent the release mechanism 23 from being accidentally activated. To facilitate insertion of the motor connection 6 of the drive shaft coupling into the stationary part 7 of the motor 8, the motor connection may have a “double-arrow shape” 35 with inclined surfaces being inclined towards the longitudinal axis X in the insertion direction I, when seen in cross-section, as shown in FIG. 5. The gripping elements 20 may also have a similar “reversed” arrow-shape when seen in cross-section, as shown in FIG. 5, with inclined surfaces 36 being inclined towards the longitudinal axis X in the insertion direction I to facilitate insertion of the double-arrow-shaped 35 motor connection 6.

According to an aspect of the disclosure, a container assembly 18 may be provided, comprising a drive shaft system 1 and a container 2 for a bioreaction, such as a flexible container 2, preferably for single use, wherein the drive shaft coupling 4 is connected to the e.g. flexible container 2 with the container connection 5, such as the bag connection 5, wherein a drive shaft portion 19 provided with the agitation device 13 extending between the drive shaft coupling 4 and the second drive shaft end 12 is enclosed by the container 2, such as the flexible container 2 (as e.g. shown in FIG. 2). In an inoperational state, such as when transporting the container assembly 18, the flexible container 2 may be folded around the drive shaft portion 19 extending between the drive shaft coupling 4 and the second drive shaft end 12. Therein, the flexible container 2 may be configured for expanding radially away from the drive shaft portion 19 extending between the drive shaft coupling 4 and the second drive shaft end 12 to reach the operational state from the inoperational state.

Another aspect of the disclosure concerns a method for mounting an aforementioned container assembly 18 in a container holder 3, such as a flexible container holder 3, for holding the container 2, such as the flexible container 2, comprising the step of:
detachably connecting the motor 8 with the stationary part 7 to the motor connection 6 of the drive shaft coupling 4, in such a way, that the first drive shaft end 10 is able to drive the drive shaft 9 around the longitudinal axis X, in order to rotate the agitation device 13.

The aforementioned method, according to the present disclosure, comprises the further step of:
detachably connecting the motor connection 6 of the drive shaft coupling 4 to the stationary part 7 of the motor 8 of the container holder 3 in such a way, that the first alignment element 25, 26 is rotationally aligned with the second alignment element 27, 28 provided on the stationary part 7 of the motor 8 (as shown in FIGS. 4 and 7).

The aforementioned method may comprise the further step of:
rotationally aligning the first alignment element 25, 26 and second alignment element 27, 28 in such a way, that, in the operational state, the inlet and/or outlet ports 30 and/or sensor ports 30 of the container 2 are situated near the mounting opening 29 of the container holder 3 (as e.g. shown in FIG. 1).

The aforementioned method may comprise the further step of:
detachably connecting the drive shaft coupling 4 to the stationary part 7 of the motor 8, in such a way, that the one or more gripping elements 20 of the stationary part 7 of the motor 8 radially engage the motor connection 6 (as shown in FIGS. 5 and 7).

Although the disclosure has been described above with reference to example embodiments, variants within the scope of the present disclosure will readily occur to those skilled in the art after reading the above description. Such variants are within the scope of the independent claims and the dependent claims. In addition, it is to be understood that express rights are requested for variants as described in the dependent claims. It should also be noted that the example embodiments shown in the Figures, or features thereof, may be combined to yield embodiments not explicitly shown in the Figures.

### LIST OF REFERENCE NUMERALS

1. Drive shaft system
2. (Single-use) flexible container
3. (Multi-use) flexible container holder
4. Drive shaft coupling
5. Bag connection
6. Motor connection
7. Stationary part of motor
8. Motor
9. Drive shaft
10. First drive shaft end
11. Rotatable output shaft end of motor
12. Second drive shaft end
13. Agitation device
14. Alignment teeth of first drive shaft end
15. Alignment surface
16. Insertion edge
17. Tri-clamp connection
18. (Single-use) flexible container assembly
19. Drive shaft portion between drive shaft coupling and second drive shaft end
20. Gripping element
21. Outer circumference of motor connection
22. Spring
23. Release button
24. Safety latch
25. Lower notch
26. Upper notch
27. Lower protrusion
28. Upper protrusion
29. Mounting opening
30. Inlet/outlet/sensor ports
31. Control panel
32. Flexible container holder enclosure
33. Holder arm
34. Alignment teeth of rotatable output shaft end of motor
35. Double-arrow shape of motor connection
36. Inclined surface of gripping element
37. Mechanical linkage
X. Longitudinal/rotational axis
C. Circumferential direction
I. Insertion direction
α. Angle enclosed by alignment surfaces
β. Backwards angle of insertion edge

1-35. (canceled)

36. Container assembly comprising:
a drive shaft system for use with a container for mixing a fluid and a container holder for holding the container,
the container for mixing the fluid, wherein the container for mixing the fluid is a container for a bioreaction, the drive shaft system comprising:
a drive shaft coupling having:
a container connection for connecting the drive shaft coupling to the container, wherein the drive shaft coupling is connected to the container with the container connection;
a motor connection for detachably connecting the drive shaft coupling to a stationary part of a motor of the container holder, wherein the motor connection is provided with a first alignment element to be rotationally aligned with a second alignment element provided on the stationary part of the motor;
a drive shaft, rotatably arranged in the drive shaft coupling, having:
a first drive shaft end configured for detachable coupling to a rotatable output shaft end of the motor;
a second drive shaft end; and
an agitation device, connected to the drive shaft, wherein a drive shaft portion provided with the agitation device extending between the drive shaft coupling and the second drive shaft end is enclosed by the container, wherein the container is a flexible container,
wherein, in an operational state, the drive shaft is configured for being driven around a longitudinal axis of the drive shaft by the motor, in order to rotate the agitation device for mixing the fluid,
wherein the container holder comprises:
the motor with the stationary part for detachable connection to the motor connection of the drive shaft coupling, wherein the second alignment element is provided on the stationary part of the motor, for rotational alignment with the first alignment element provided on the motor connection of the drive shaft coupling;
wherein the motor comprises the rotatable output shaft end configured for detachable coupling to the first drive shaft end for driving the drive shaft around the longitudinal axis, in order to rotate the agitation device.

37. Container assembly according to claim 36, wherein the container is configured for single use.

38. Container assembly according to claim 37, wherein the flexible container comprises a bag, wherein the container connection is a bag connection for connecting the drive shaft coupling to the bag.

39. Container assembly according to claim 36, wherein, in an inoperational state, the flexible container is folded around the drive shaft portion extending between the drive shaft coupling and the second drive shaft end.

40. Container assembly according to claim 36, wherein the flexible container is configured for expanding radially away from the drive shaft portion extending between the drive shaft coupling and the second drive shaft end to reach the operational state from the inoperational state.

41. Container assembly according to claim 36, wherein the motor connection is provided with multiple first alignment elements.

42. Container assembly according to claim 36, wherein at least one of the first alignment element and the multiple first alignment elements and at least one of the second alignment element and the multiple second alignment elements are provided in such a way, that, in the operational state, at least one of the inlet ports, outlet ports and sensor ports of the container are situated near a mounting opening of the container holder.

43. Container assembly according to claim 36, wherein the first drive shaft end is configured to be self-aligning with the motor output shaft end of the motor.

44. Container assembly according to claim 43, wherein the first drive shaft end comprises one or more alignment teeth spaced-apart in a circumferential direction along the first drive shaft end.

45. Container assembly according to claim 44, wherein the one or more alignment teeth comprise two circumferentially opposing alignment surfaces converging towards each other in an insertion direction.

46. Container assembly according to claim 45, wherein the two opposing alignment surfaces enclose an angle of 90 degrees or less.

47. Container holder for holding a container for mixing a fluid, wherein the container for mixing the fluid is a container for a bioreaction, comprising a container assembly according to claim 36, comprising:
the motor with the stationary part detachably connected to the motor connection of the drive shaft coupling, wherein the second alignment element is provided on the stationary part of the motor, for rotational alignment with the first alignment element provided on the motor connection of the drive shaft coupling;
wherein the motor comprises the rotatable output shaft end configured for detachable coupling to the first drive shaft end for driving the drive shaft around the longitudinal axis, in order to rotate the agitation device.

48. Container holder according to claim 47, wherein multiple second alignment elements are provided on the stationary part of the motor.

49. Container holder according to claim 47, wherein the stationary part is detachably connected to the motor connection of the drive shaft coupling and wherein the rotatable output shaft end is detachably coupled to the first drive shaft end for driving the drive shaft around the longitudinal axis, in order to rotate the agitation device.

50. Container holder according to claim 47, wherein the stationary part of the motor comprises one or more gripping elements configured for radially engaging the motor connection for detachably connecting the drive shaft coupling to the stationary part of the motor.

51. Container holder according to claim 50, wherein the one or more gripping elements are configured for radially engaging an outer circumference of the motor connection, wherein the one or more gripping elements are configured to engage the outer circumference in a radially inward position and to disengage the outer circumference in a radially outward position.

52. Container holder according to claim 50, wherein the stationary part of the motor comprises a release mechanism, that, when activated, causes the one or more gripping elements to radially disengage the motor connection.

53. Container holder according to claim 50, wherein the stationary part of the motor comprises a safety mechanism, that, when activated, prevents the one or more gripping elements from accidentally disengaging the motor connection.

54. Method for mounting a container assembly in a container holder, comprising the steps of:
(a) providing a container assembly defined in claim 36;
(b) providing a container holder, wherein the motor with the stationary part is detachably connected to the motor connection of the drive shaft coupling, wherein the second alignment element is provided on the stationary part of the motor, for rotational alignment with the first alignment element provided on the motor connection of the drive shaft coupling, and wherein the motor comprises the rotatable output shaft end configured for detachable coupling to the first drive shaft end for driving the drive shaft around the longitudinal axis, in order to rotate the agitation device; and
(c) detachably connecting the motor with the stationary part to the motor connection of the drive shaft coupling, in such a way, that the first drive shaft end is able to drive the drive shaft around the longitudinal axis, in order to rotate the agitation device, and in such a way, that the first alignment element is rotationally aligned with the second alignment element provided on the stationary part of the motor.

55. Method according to claim 54, comprising the further step of:
rotationally aligning the first alignment element and second alignment element in such a way, that, in the operational state, at least one of the inlet ports, outlet ports and sensor ports of the container are situated near the mounting opening of the container holder.
